(19) United States
(12) Patent Application Publication
(10) Pub. No.: US 2017/0307150 A1
(43) Pub. Date: Oct. 26, 2017

(54) FORMABLE THREE-DIMENSIONAL LIGHTING DEVICES

(71) Applicant: OSRAM SYLVANIA Inc., Wilmington, MA (US)

(72) Inventors: Qi Dai, Shanghai (CN); Bruce Radl, Stow, MA (US); Richard Speer, Concord, MA (US); Rodrigo Pereyra, Salem, MA (US); Qiong Huang, Winchester, MA (US); Douglas Harriott, Melrose, MA (US); Zhuo Wang, Middleton, MA (US)

(73) Assignee: OSRAM SYLVANIA Inc., Wilmington, MA (US)

(21) Appl. No.: 15/513,981

(22) PCT Filed: Sep. 23, 2015
(86) PCT No.: PCT/US15/51703

§ 371 Date: Mar. 23, 2017

Related U.S. Application Data
(60) Provisional application No. 62/054,033, filed on Sep. 23, 2014.

(51) Int. Cl. F21S 4/22; F21V 19/00; F21V 23/06; F21Y 2107/00

(52) U.S. Cl. CPC F21S 4/22; F21V 23/06; F21V 19/003; F21Y 2107/00

(57) ABSTRACT

A formed lighting device having a shape that extends in three dimensions is provided. The formed lighting device includes a formed flexible substrate having a shape, and a stretchable conductive trace located on the formable flexible substrate. A plurality of solid state light sources are attached to the stretchable conductive trace. The shape of the substrate, and thus the lighting device, extends in three dimensions and includes a three-dimensional structure that beam shapes light emitted from one of the solid state light sources. The three-dimensional structure may be a plurality of peaks and a corresponding plurality of valleys. A set of solid state light sources in the plurality of solid state light sources may be located in the plurality of valleys.

### CROSS-REFERENCE TO RELATED APPLICATION

The present application is an international application of, and claims priority to, U.S. Provisional Patent Application No. 62/054,033, entitled “FORMABLE THREE-DIMENSIONAL LIGHTING MODULES AND DEVICES” and filed Sep. 23, 2014, the entire contents of which are hereby incorporated by reference.

### TECHNICAL FIELD

The present invention relates to lighting, and more specifically, to lighting devices on formable materials.

### BACKGROUND

Conventional light engines including solid state light sources are typically made on a rigid, or substantially rigid, substrate, such as but not limited to FR4, metal core PCB, etc. The conventional light engine is then placed within a lighting device (e.g., lamp, luminaire, etc.) that usually includes an optical system (e.g., one or more lenses, one or more diffusers, one or more reflectors, one or more transparent covers, etc., including varied combinations thereof). The optical system then beam shapes light emitted from the solid state light source(s) of the light engine, causing the lighting device to emit light.

### SUMMARY

Embodiments provide a formed three-dimensional lighting device that itself provides for beam shaping of light emitted therefrom without a separate optical system. The lighting device is also its own substrate and heat sink, removing the need for a housing as well. In some embodiments, a sheet of formable flexible substrate material includes a stretchable conductor. The formable substrate material is then formed (e.g., thermoformed) into a shape that extends in three dimensions and includes a plurality of peaks and a plurality of valleys. The forming of the material does not break the stretchable conductor. Either before, during, or after the forming, one or more solid state light sources are populated on the substrate material, and more particularly, in contact with the stretchable conductor. The solid state light sources are located in the valleys, on the peaks, or combinations thereof. Indeed, it is possible to locate the solid state light sources anywhere there is a stretchable conductor. The peaks and valleys, in combination with the location of the solid state light sources, beam shape light emitted by the solid state light sources without the need for a separate optical system.

In an embodiment, there is provided a lighting device. The lighting device includes: a formed flexible substrate having a shape; a stretchable conductive trace located on the formable flexible substrate; and a plurality of solid state light sources attached to the stretchable conductive trace; wherein the shape of the formed flexible substrate extends in three dimensions and comprises a three-dimensional structure, wherein a solid state light source in the plurality of solid state light sources is located so that light emitted therefrom is beam shaped by the three-dimensional structure.

In a related embodiment, the three-dimensional structure may include a plurality of three-dimensional structures.

In a further related embodiment, the plurality of three-dimensional structures may include a plurality of peaks and a corresponding plurality of valleys, a set of solid state light sources in the plurality of solid state light sources may be located in the plurality of valleys. In a further related embodiment, each valley in the plurality of valleys may include a solid state light source from the set of solid state light sources. In a further related embodiment, at least one solid state light source may be located in a low point of the valley. In another further related embodiment, at least one peak in the plurality of peaks may include a solid state light source in the plurality of solid state light sources. In yet another further related embodiment, each valley may be defined by a first wall having a slope and a second wall having a slope. In a further related embodiment, a first valley in the plurality of valleys may be defined by a first wall having a first height and a second wall having a second height, the first height may exceed the second height.

In another further related embodiment, each valley in the plurality of valleys may have a valley width, each peak in the plurality of peaks may have a peak width, and the valley width may exceed the peak width. In a further related embodiment, a first valley and a last valley in the plurality of valleys may each have a first valley width, a remainder of valleys in the plurality of valleys may all have a second valley width, and the first valley width may exceed the second valley width. In another further related embodiment, a central peak in the plurality of peaks may have a first peak width, a remainder of peaks in the plurality of peaks may all have a second peak width, and the first peak width may exceed the second peak width.

In another related embodiment, the stretchable conductive trace may include a stretchable conductive ink. In a further related embodiment, the stretchable conductive trace may include a plurality of stretchable conductive traces, each comprising stretchable conductive ink. In a further related embodiment, each stretchable conductive trace in the plurality of stretchable conductive traces may have a width.

In still another related embodiment, the stretchable conductive trace may include a plurality of stretchable conductive traces, each comprising stretchable conductive ink. In a further related embodiment, a first set of stretchable conductive traces in the plurality of stretchable conductive traces may have a first width, and a second set of stretchable conductive traces in the plurality of stretchable conductive traces may have a second width. In a further related embodiment, the first set of stretchable conductive traces may all be located in the plurality of valleys and the second set of stretchable conductive traces may all be located on the plurality of peaks. In a further related embodiment, the width of a stretchable conductive trace may depend on the location of the stretchable conductive trace.

In yet another related embodiment, the stretchable conductive trace may include a plurality of stretchable conductive traces.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1A shows a sheet of formable flexible substrate having stretchable conductive traces located thereon, according to embodiments disclosed herein.

FIG. 1B shows the formable flexible substrate of FIG. 1A after being formed into a shape, with at least one solid state light source located thereon, according to embodiments disclosed herein.

FIG. 1C shows a portion of the formable flexible substrate of FIG. 1A after being formed into a shape including a three-dimensional structure, according to embodiments disclosed herein.

FIG. 1D shows the portion of the formed shaped flexible substrate of FIG. 1C including solid state light sources to form a lighting device, according to embodiments disclosed herein.

FIG. 1E shows the lighting device of FIG. 1D with the solid state light sources illuminated, according to embodiments disclosed herein.

FIG. 2A illustrates a lighting device according to embodiments disclosed herein.

FIG. 2B illustrates another lighting device according to embodiments disclosed herein.

### DETAILED DESCRIPTION

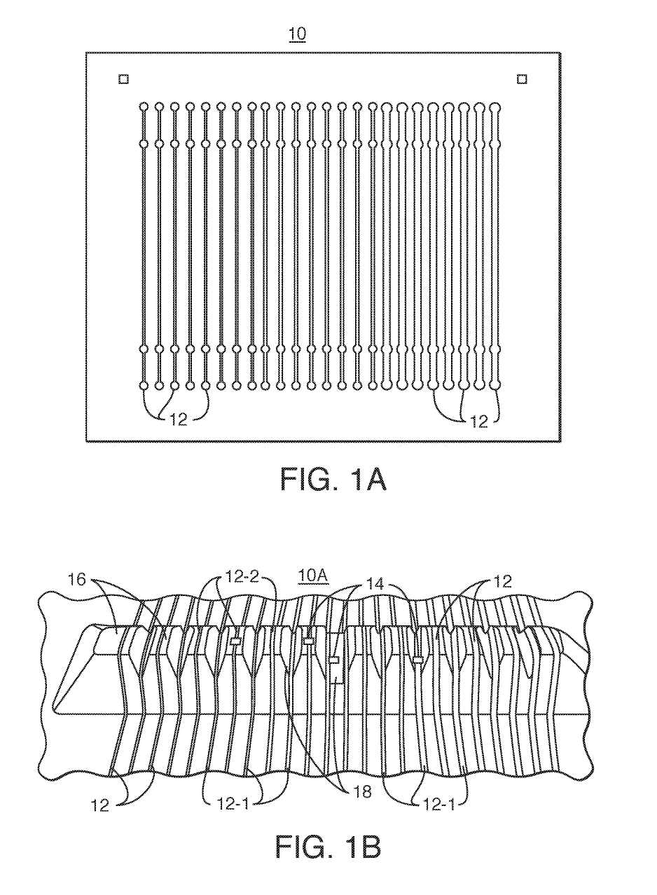

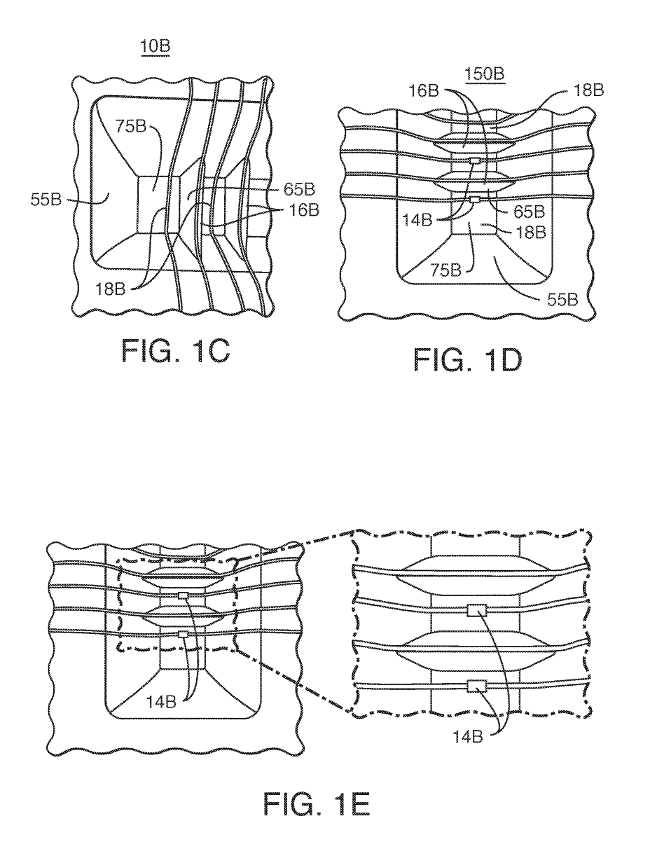

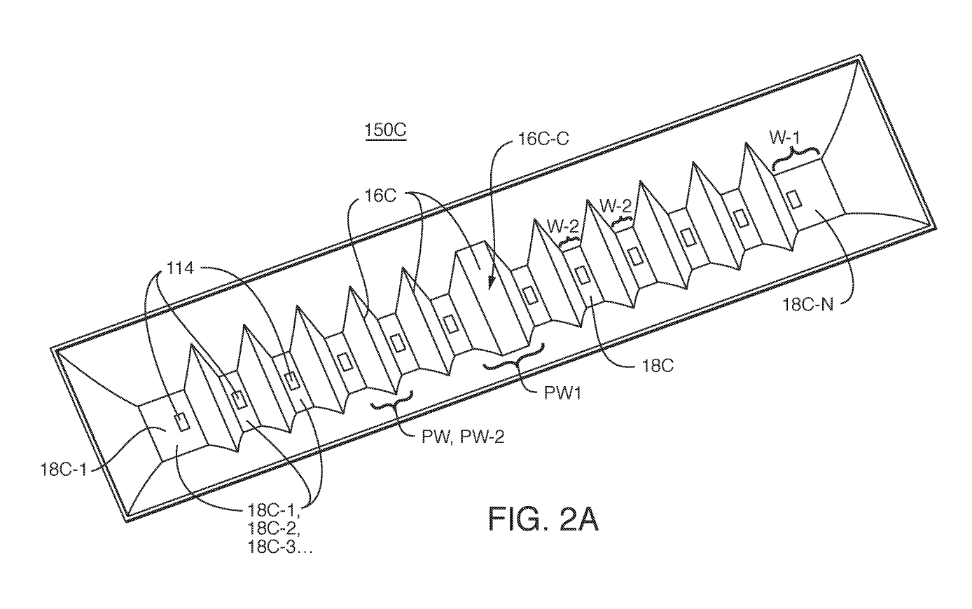

FIG. 1 shows a sheet of formable flexible substrate 10. The formable flexible substrate 10 is made of a formable material that is capable of having one or more stretchable conductive traces 12 placed thereon. In some embodiments, the formable flexible substrate 10 is made of a formable polymer material, such as but not limited to polycarbonate, polyethylene terephthalate (PET), polyethylene naphthalate (PEN), polyvinyl chloride (PVC), polystyrene (PS), combinations thereof, and the like. The formable flexible substrate 10, in some embodiments, has a relatively high glass-transition temperature, so that the formable flexible substrate 10 does not show warpage during forming, and/or during curing of the stretchable conductive traces placed thereon. The formable flexible substrate 10, in some embodiments, has one or more optical properties, as is explained in greater detail below.

The stretchable conductive traces 12 are placed onto the formable flexible substrate 10. In some embodiments, the stretchable conductive traces 12 comprise stretchable conductive ink 12, such as but not limited to Dupont 5042 and 5043 ink. The stretchable conductive ink 12 or other conductor used should cure at a temperature (such as but not limited to 140° C.) that will not cause warpage of the formable flexible substrate 10 during forming. The formable flexible substrate 10 is then formed (e.g., thermoformed, plastic deformed, etc.) into a shape extending in three dimensions. An example of such a formed flexible substrate 10A is shown in FIG. 1B. During the forming, the continuity of the stretchable conductive traces 12 are maintained, and thus the stretchable conductive traces 12 not broken or damaged in any way that prevents the stretchable conductive traces 12 from being able to conduct.

The forming of the formable flexible substrate 10 occurs using any known techniques, such as but not limited to using a mold that presses the desired shape extending in three dimensions into the formable flexible substrate 10, to create a formed flexible substrate. In some embodiments, the formed flexible substrate 10A includes one or more three-dimensional structures 16, 18. In some embodiments, the formed flexible substrate 10A includes a plurality of peaks 16 and a corresponding plurality of valleys 18.

The stretchable conductive traces 12 are able to accommodate the formed shape, as described above. As shown in FIGS. 1A and 1B, for example, the width of the stretchable conductive traces 12 may, and in some embodiments does, vary. This variation in width, in some embodiments, is due to the particular shape that is to be formed into the formable flexible substrate 10. In some embodiments, the variation in width is due to the location of the stretchable conductive trace 12 on the formed flexible substrate 10A.

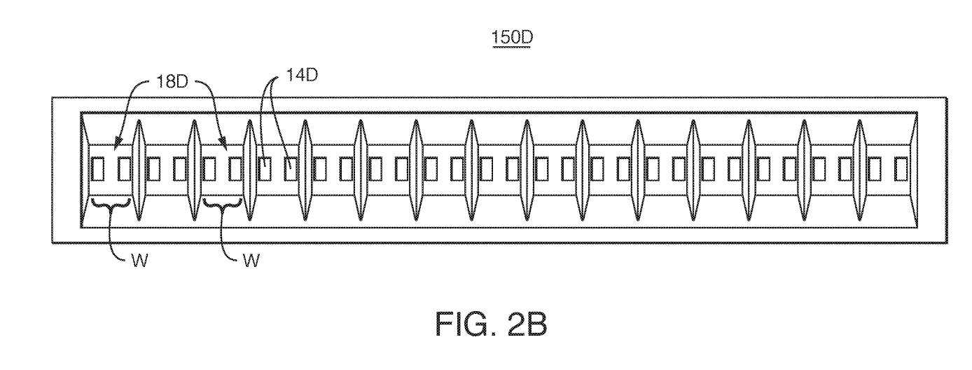

One or more solid state light sources 14 are then attached to the formed flexible substrate 10A and one or more stretchable conductive traces 12 using any known method and/or method, such as but not limited to a conductive epoxy. The one or more solid state light sources 14 are located such that light emitted from one of the one or more solid state light sources 14 is beam shaped by the three-dimensional structure 16, 18. In some embodiments, the one or more solid state light sources 14 are thus located on the three-dimensional structures 16, 18, and in some embodiments are thus between the three-dimensional structures 16, 18. In some embodiments, the one or more solid state light sources 14 are thus located in the plurality of valleys 18. In some embodiments, such as shown in a lighting device 150C in FIG. 2A, each valley 18C in a plurality of valleys 18C-1, 18C-2, 18C-3, . . . 18C-N includes a solid state light source 114. In some embodiments, such as shown in FIG. 1B, one or more peaks 16 include a solid state light source 14. The amount of, and thus shape of, the formable flexible substrate 10, and/or the material used therein and/or its rigidity and/or its flexibility and/or any other feature thereof, in some embodiments, are varied depending on one or more the desired use application, beam shaping, amount of light output, and so forth. Further, in some embodiments, the material of the formable flexible substrate 10 is used based on the type of stretchable conductive trace used. For example, in some embodiments, certain formable polymers work better with certain stretchable conductive materials than other stretchable conductive materials.

The three-dimensional structure(s) 16, 18 and/or plurality of peaks and valleys 16, 18 created during the forming process act to beam shape the light emitted by the one or more solid state light sources 14. In embodiments where the formed flexible substrate 10A is a reflective material, or otherwise possesses reflective properties, this enhances the beam shaping. In some embodiments, the formed flexible substrate 10A exhibits other optical effects upon emitted light, such as but not limited to glare reduction. In some embodiments, the formed flexible substrate 10A performs more than one optical function (e.g., beam shaping, reflecting, and glare reduction).

A portion of a formed flexible substrate 10B is shown in FIG. 1C, which includes a plurality of peaks 16B and a corresponding plurality of valleys 18B. FIG. 1D shows the portion of the formed flexible substrate 10B of FIG. 1C as a lighting device 150B including solid state light sources 14B. FIG. 1E shows the lighting device 150B with the solid state light sources 14B emitting light, as shown more clearly in the cutout. As seen in FIGS. 1C-1E, each valley 18B is defined by a first wall 55B and a second wall 65B. Each wall 55B, 65B has a slope. In some embodiments, the slopes are the same, in some embodiments the slopes are similar (i.e., substantially the same), and in some embodiments, the slopes are different. Further, each wall 55B, 65B has a height. In some embodiments, such as shown most clearly in FIG. 1D, the height of the first wall 55B exceeds the height of the second wall 65B. In some embodiments, this relationship is inversed. Each valley 18B has a floor 75B, which is a low point of the valley 18B. In some embodiments, the solid state light source 14B is located on the floor 75B and thus is at located at the low point of the valley 18B.

Valleys also have widths, as seen most clearly in the lighting device 150C shown in FIG. 2A and the lighting device 150D shown in FIG. 2B. In the lighting device 150D, each valley 18D has a width W. The width W of each valley 18D is the same, or substantially the same. In the lighting device 150C, however, a first valley 18C-1 and a last valley 18C-N in the plurality of valleys 18C-1, 18C-2, 18C-3, . . . 18C-N each have a first valley width W-1. A remainder of valleys 18C-2, 18C-3, etc. in the plurality of valleys 18C-1, 18C-2, 18C-3, . . . 18C-N all have a second valley width W-2. The first valley width W-1 exceeds the second valley width W-2.

Peaks also have associated properties, such as slopes, heights, and widths, as seen in FIGS. 1B-2B. For example, in the lighting device 150C of FIG. 2A, each peak 16C in the plurality of peaks 16C has a peak width PW. Some of the peak widths PW are the same, and some are different. The peak width PW shown in FIG. 2A is less than the valley width W-1, but similar to the valley width W-2. Further, as shown in FIG. 2A, a central peak 16C-C in the plurality of peaks 16C has a first peak width PW-1, and the rest of the peaks 16C all have a second peak width PW-2. The first peak width PW-1 exceeds the second peak width PW-2. The slope of a wall, and/or the height of a wall, and/or the width of the valley and/or peak, all impact the beam-shaping and other optical properties of the valley and/or peak. Thus, the shape of each three-dimensional structure, and its location in relationship to one or more of the other three-dimensional structures, impacts the beam-shaping and other optical properties of the lighting device. Certain combinations, placements, and sizes of three-dimensional structures will give certain optical properties, and thus shapes for the lighting device are chosen accordingly.

The placement of solid state light sources on a formed flexible substrate is dependent on the location of the stretchable conductive traces, as the traces provide electric power to the solid state light sources. Thus, in some embodiments, the location of one or more stretchable conductive traces is critical to creating a certain light output. In some embodiments, as seen most clearly in FIG. 1B, a set of stretchable conductive traces 12-1 are all located in the plurality of valleys 18, and a second set of stretchable conductive traces 12-2 are all located on the plurality of peaks 16. In some embodiments, such as shown in FIG. 2A, all of the stretchable conductive traces 12C are located in the plurality of valleys 18C.

Though embodiments are described in terms of peaks and valleys as three-dimensional structures, embodiments are not so limited. Three-dimensional structures, in some embodiments, include any type of three-dimensional structure that extends out from the formed flexible substrate. The structures need not be repeated in any pattern, though in some embodiments there is a pattern to the structures.

Though embodiments are shown as having a substantially flat surface where the one or more solid state light sources are attached to the formed flexible substrate, embodiments are not so limited. Thus, in some embodiments, the formed flexible substrate includes a ridge, depression, or other feature on which a solid state light source is placed. In some embodiments, this feature does not beam shape light emitted by the solid state light source placed thereon. In some embodiments, it does. Further, some embodiments, such as the lighting device 150D of FIG. 2B, include more than one solid state light source 14D in a valley. Further, though embodiments are shown as having only solid state light sources placed on stretchable conductive traces on the formed flexible substrate, embodiments are not so limited. Thus, in some embodiments, other electrical components are attached to the stretchable conductive traces to create circuitry thereon, such as but not limited to resistors, capacitors, inductors, transformers, fuses, transistors, ICs, microchips, and the like.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A lighting device, comprising:
a formed flexible substrate having a shape;
a stretchable conductive trace located on the formable flexible substrate; and
a plurality of solid state light sources attached to the stretchable conductive trace;
wherein the shape of the formed flexible substrate extends in three dimensions and comprises a three-dimensional structure, wherein a solid state light source in the plurality of solid state light sources is located so that light emitted therefrom is beam shaped by the three-dimensional structure.

2. The lighting device of claim 1, wherein the three-dimensional structure comprises a plurality of three-dimensional structures.

3. The lighting device of claim 2, wherein the plurality of three-dimensional structures comprises a plurality of peaks and a corresponding plurality of valleys, wherein a set of solid state light sources in the plurality of solid state light sources is located in the plurality of valleys.

4. The lighting device of claim 3, wherein each valley in the plurality of valleys includes a solid state light source from the set of solid state light sources.

5. The lighting device of claim 4, wherein at least one solid state light source is located in a low point of the valley.

6. The lighting device of claim 4, wherein at least one peak in the plurality of peaks includes a solid state light source in the plurality of solid state light sources.

7. The lighting device of claim 4, wherein each valley is defined by a first wall having a slope and a second wall having a slope.

8. The lighting device of claim 7, wherein a first valley in the plurality of valleys is defined by a first wall having a first height and a second wall having a second height, wherein the first height exceeds the second height.

9. The lighting device of claim 4, wherein each valley in the plurality of valleys has a valley width, wherein each peak in the plurality of peaks has a peak width, and wherein the valley width exceeds the peak width.

10. The lighting device of claim 9, wherein a first valley and a last valley in the plurality of valleys each have a first valley width, wherein a remainder of valleys in the plurality of valleys all have a second valley width, and wherein the first valley width exceeds the second valley width.

11. The lighting device of claim 9, wherein a central peak in the plurality of peaks has a first peak width, wherein a remainder of peaks in the plurality of peaks all have a second peak width, and wherein the first peak width exceeds the second peak width.

12. The lighting device of claim 1, wherein the stretchable conductive trace comprises a stretchable conductive ink.

13. The lighting device of claim 12, wherein the stretchable conductive trace comprises a plurality of stretchable conductive traces, each comprising stretchable conductive ink.

14. The lighting device of claim 13, wherein each stretchable conductive trace in the plurality of stretchable conductive traces has a width.

15. The lighting device of claim 3, wherein the stretchable conductive trace comprises a plurality of stretchable conductive traces, each comprising stretchable conductive ink.

16. The lighting device of claim 15, wherein a first set of stretchable conductive traces in the plurality of stretchable conductive traces has a first width, and wherein a second set of stretchable conductive traces in the plurality of stretchable conductive traces has a second width.

17. The lighting device of claim 16, wherein the first set of stretchable conductive traces are all located in the plurality of valleys and wherein the second set of stretchable conductive traces are all located on the plurality of peaks.

18. The lighting device of claim 17, wherein the width of a stretchable conductive trace depends on the location of the stretchable conductive trace.

19. The lighting device of claim 1, wherein the stretchable conductive trace comprises a plurality of stretchable conductive traces.
